(19) United States
(12) Patent Application Publication
(10) Pub. No.: US 2013/0175809 A1
(43) Pub. Date: Jul. 11, 2013

(54) VEHICLE

(71) Applicants: Koji YAMAMOTO, Okazaki-shi (JP); Takayoshi OKUDA, Nagoya-shi (JP); Hideaki YAGUCHI, Toyota-shi (JP); Toshiya HASHIMOTO, Miyoshi-shi (JP)

(72) Inventors: Koji YAMAMOTO, Okazaki-shi (JP); Takayoshi OKUDA, Nagoya-shi (JP); Hideaki YAGUCHI, Toyota-shi (JP); Toshiya HASHIMOTO, Miyoshi-shi (JP)

(21) Appl. No.: 13/719,430

(22) Filed: Dec. 19, 2012

(30) Foreign Application Priority Data
Jan. 5, 2012 (JP) 2012-000765

(51) Int. Cl. F02N 11/08

(52) U.S. Cl. CPC F02N 11/0844
USPC 290/38 C

(57) ABSTRACT

A hybrid vehicle includes a first motor-generator, which allows cranking an engine, and an inverter, which drives the first motor-generator. During running of the vehicle, when an operation to stop the hybrid system is performed, and then when an operation to start a hybrid system is performed before the vehicle stops, an HVECU operates the inverter.

### INCORPORATION BY REFERENCE

The disclosure of Japanese Patent Application No. 2012-000765 filed on Jan. 5, 2012 including the specification, drawings and abstract is incorporated herein by reference in its entirety.

### BACKGROUND OF THE INVENTION

1. Field of the Invention

The present invention relates to a vehicle including an engine.

2. Description of Related Art

As a related technique, the following hybrid vehicle is known. That is, the hybrid vehicle includes an engine, a first motor-generator, a power split mechanism, and a second motor-generator. The first motor-generator mainly functions as an electric generator. The power split mechanism splits the power of the engine to transmit the power to a driving wheel and the first motor-generator. The second motor-generator mainly functions as an electric motor (see, for example, Japanese Patent Application Publication No. 2005-306238 (JP 2005-306238 A)).

The hybrid vehicle disclosed in JP 2005-306238 A includes a first inverter and a second inverter. The first inverter drives the first motor-generator. The second inverter drives the second motor generator. The first inverter and the second inverter include a plurality of switching elements. This hybrid vehicle is configured to shut down the first inverter and the second inverter (cutting off of the switching elements at the gates) in the case where a shift position is in a neutral position. In this hybrid vehicle, when the engine starts, the first inverter drives the first motor-generator to crank the engine for starting.

This hybrid vehicle generally includes a power switch, which allows a driver (a person who drives a car) to start and stop a hybrid system (a vehicle system).

In this case, in the case where the driver stops the hybrid system during running of the hybrid vehicle, the driver possibly starts the hybrid system before the hybrid vehicle stops running (during freewheeling).

However, in the hybrid vehicle in the related technique, in the case where the shift position is in the neutral position when the hybrid system is started again, the first inverter is assumed to be shut down. In such case, because the first motor-generator is not driven, the hybrid vehicle can not crank the engine for starting.

### SUMMARY OF THE INVENTION

The present invention provides a vehicle that allows cranking of en engine in the case where a starting operation for a vehicle system is performed after a stopping operation for the vehicle system is performed during running of the vehicle.

A vehicle according to a first aspect of the present invention includes an engine, a first electric machine configured to allow cranking the engine, a first inverter configured to drive the first electric machine, a control unit that controls the first inverter, an operating unit that receives operations to start and stop a vehicle system. The vehicle system is a system that controls running of the vehicle. The control unit is configure so that, during running of the vehicle, when the operating unit receives the operation to stop the vehicle system, and then the operating unit receives the operation to start the vehicle system before the vehicle stops, the control unit operates the first inverter.

According to the first aspect of the present invention, the first inverter is operated to drive the first electric motor to crank the engine for starting.

A vehicle according to a second aspect of the present invention includes an engine, a first electric machine configured to allow cranking the engine, a first inverter disposed to drive the first electric machine, a control unit that controls the first inverter, an operating unit that receives operations to start and stop a vehicle system. The vehicle system is a system that controls running of the vehicle. The control unit is configured so that, during running of the vehicle, when the operating unit receives the operation to stop the vehicle system, and then the operating unit receives the operation to start the vehicle system before the vehicle stops, the control unit causes the second inverter to operate.

According to the second aspect of the present invention, the first inverter is operated to drive the first electric motor to crank the engine for starting.

A vehicle according to a third aspect of the present invention includes an engine, a first electric machine configured to allow cranking the engine, a first inverter disposed to drive the first electric machine, a control unit that controls the first inverter, an operating unit that receives operations to start and stop a vehicle system. The vehicle system is a system that controls running of the vehicle. The control unit is configured so that, during running of the vehicle, when the occupant performs the operation to stop the vehicle system, and then the occupant performs the operation to start the vehicle system through the operating unit before the vehicle stops, the control unit operates the first inverter.

According to the third aspect of the present invention, the first inverter is operated to drive the first electric motor to crank the engine for starting.

The vehicle according to the first, second and third aspects of the present invention allows cranking the engine when the starting operation for the vehicle system is performed during running of the vehicle.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic configuration diagram illustrating a hybrid vehicle with an ECU according to one embodiment of the present invention;

FIG. 2 is a schematic diagram illustrating a shift operation device of the hybrid vehicle illustrated in FIG. 1;

FIG. 3 is a block diagram illustrating the ECU of the hybrid vehicle illustrated in FIG. 1;

FIG. 4 is a circuit diagram illustrating an inverter of the hybrid vehicle illustrated in FIG. 1;

FIG. 5 is a flowchart to explain a starting process of the hybrid system when the hybrid vehicle illustrated in FIG. 1 runs;

FIG. 6 is a flowchart to explain a control of system start during running at step S4 in FIG. 5; and

FIG. 7 is a schematic configuration diagram illustrating a hybrid vehicle according to a modification of this embodiment.

### DETAILED DESCRIPTION OF EMBODIMENTS

A description will be given of one embodiment of the present invention below by referring to the accompanying drawings. In this embodiment, a description will be given of a case where the present invention is applied to a front-engine, front-wheel drive (FF) hybrid vehicle.

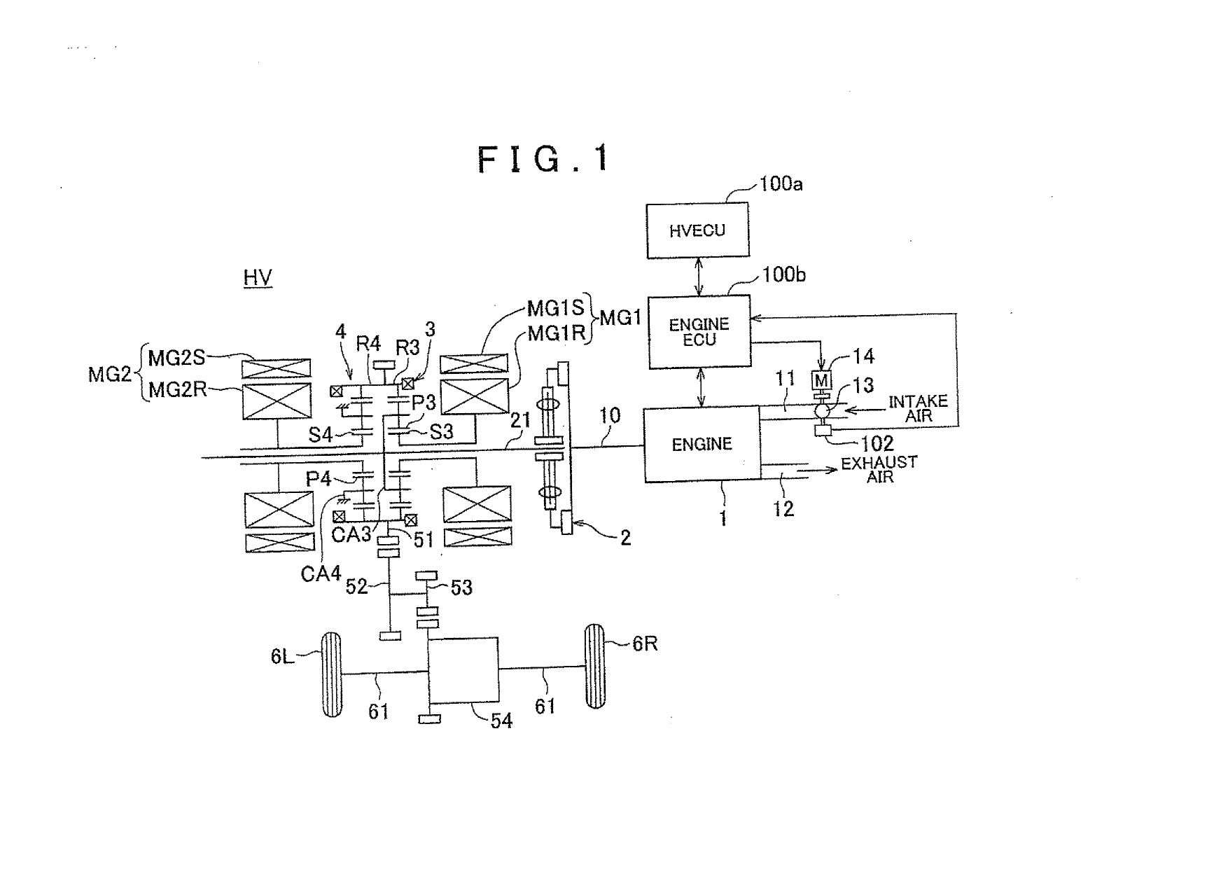

FIG. 1 is a schematic configuration diagram illustrating a hybrid vehicle according to this embodiment. As illustrated in FIG. 1, a hybrid vehicle HV includes an engine 1 (internal combustion engine), a first motor-generator MG1, a second motor-generator MG2, a power split mechanism 3, a reduction mechanism 4, a counter drive gear 51, a counter driven gear 52, a final gear 53, a differential unit 54, front wheel shafts (drive shafts) 61 and 61, front wheels (driving wheels) 6L and 6R, a Hybrid Vehicle Electronic Control Unit (HVECU) 100a, and similar member. The engine 1 generates a driving force for running of the vehicle. The first motor-generator MG1 mainly functions as an electric generator. The second motor-generator MG2 mainly functions as an electric motor.

Each of units such as the engine 1, the motor-generators MG1 and MG2, the power split mechanism 3, the reduction mechanism 4, and the HVECU 100a will be described.

The engine 1 is a known power unit (internal combustion engine), which burns fuel to output power, such as a gasoline engine and a diesel engine. Additionally, the engine 1 can control an operating state such as a throttle position (air intake quantity) of a throttle valve 13 disposed in an intake passage 11, a fuel injection quantity, and an ignition timing. Exhaust gas after burning is discharged to the outside air through an exhaust passage 12 after being purified by an oxidation catalyst (not shown).

Control of the throttle valve 13 in the engine 1 employs, for example, an electronic throttle control that controls a throttle position to obtain appropriate air intake quantity (target intake quantity) corresponding to a state of the engine 1 such as an engine speed and an accelerator pedal depressing amount (the accelerator position) by the driver. This electronic throttle control uses a throttle position sensor 102 to detect an actual throttle position of the throttle valve 13. A throttle motor 14 of the throttle valve 13 is controlled by a feedback control such that the actual throttle position coincides with a throttle position (a target throttle position) where the above-described target intake quantity is obtained.

Output of the engine 1 transmits to an input shaft 21 via a crankshaft 10 and a damper 2. The damper 2 is, for example, a coil spring-type transaxle damper, and absorbs torque variation of the engine 1.

The first motor-generator MG1 and the second motor-generator MG2 are alternating current (AC) synchronous generators that include respective rotors MG1R and MG2R and respective stators MG1S and MG2S, function as electric generators, and also function as an electric machine (an electric motor). The rotors MGIR and MG2R each include a permanent magnet that is rotatably supported relative to the input shaft 21. Three-phase winding wires are wound around the stators MG1S and MG2S. The first motor-generator MG1 is an example of “a first electric machine” of the present invention while the second motor-generator MG2 is an example of “a second electric machine” of the present invention.

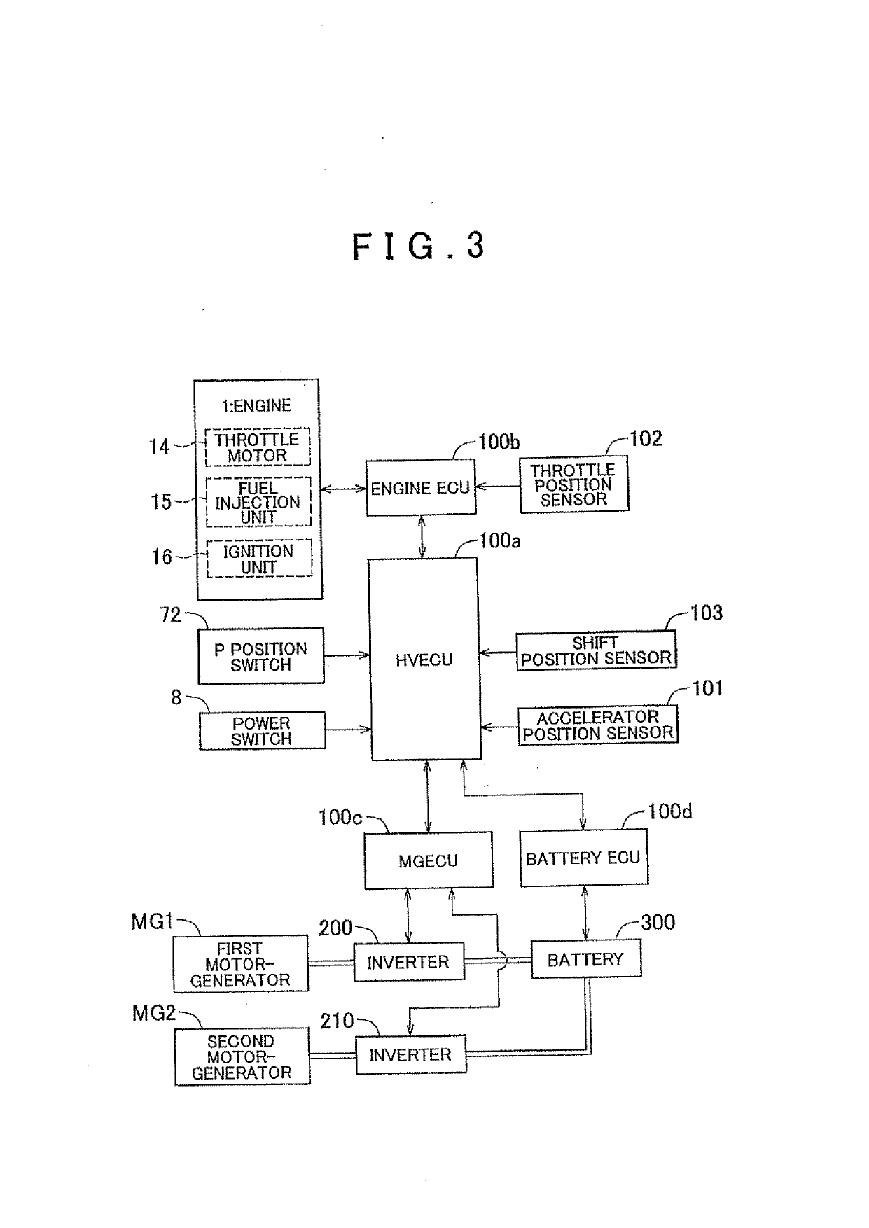

As illustrated in FIG. 3, the first motor-generator MG1 is connected to a battery (an electric storage device) 300 via inverter 200. The second motor-generator MG2 is connected to a battery 300 inerter 210. The inverters 200 and 210 are controlled by a Motor Generator Electric Control Unit (MGECU) 100c. This allows setting regenerations or power running (assist) of the respective motor-generators MG1 and MG2. At this time, the regenerative electric power is charged in the battery 300 through the inverters 200 and 210. The driving electric powers of the respective motor-generators MG1 and MG2 are supplied from the battery 300 through the inverters 200 and 210.

The inverter 200 converts a direct current from the battery 300 into an alternating current to supply this converted current to the first motor-generator MG1. Additionally, the inverter 200 converts an alternating current, which is generated by the first motor-generator MG1 using a power of the engine 1, into a direct current to supply this converted current to the battery 300.

The inverter 210 converts a direct current from the battery 300 into an alternating current to supply this converted current to the second motor-generator MG2. Additionally, the inverter 200 converts an alternating current, which is generated by the second motor-generator MG2 using regenerative brake, into a direct current to supply this converted current to the battery 300. The inverter 210 supplies the alternating current, which is generated by the first motor-generator MG1, to the second motor-generator MG2 as a driving electric power for the second motor-generator MG2 corresponding to a running state. The inverters 200 and 210 are respective examples of “a first inverter” and “a second inverter” of the present invention.

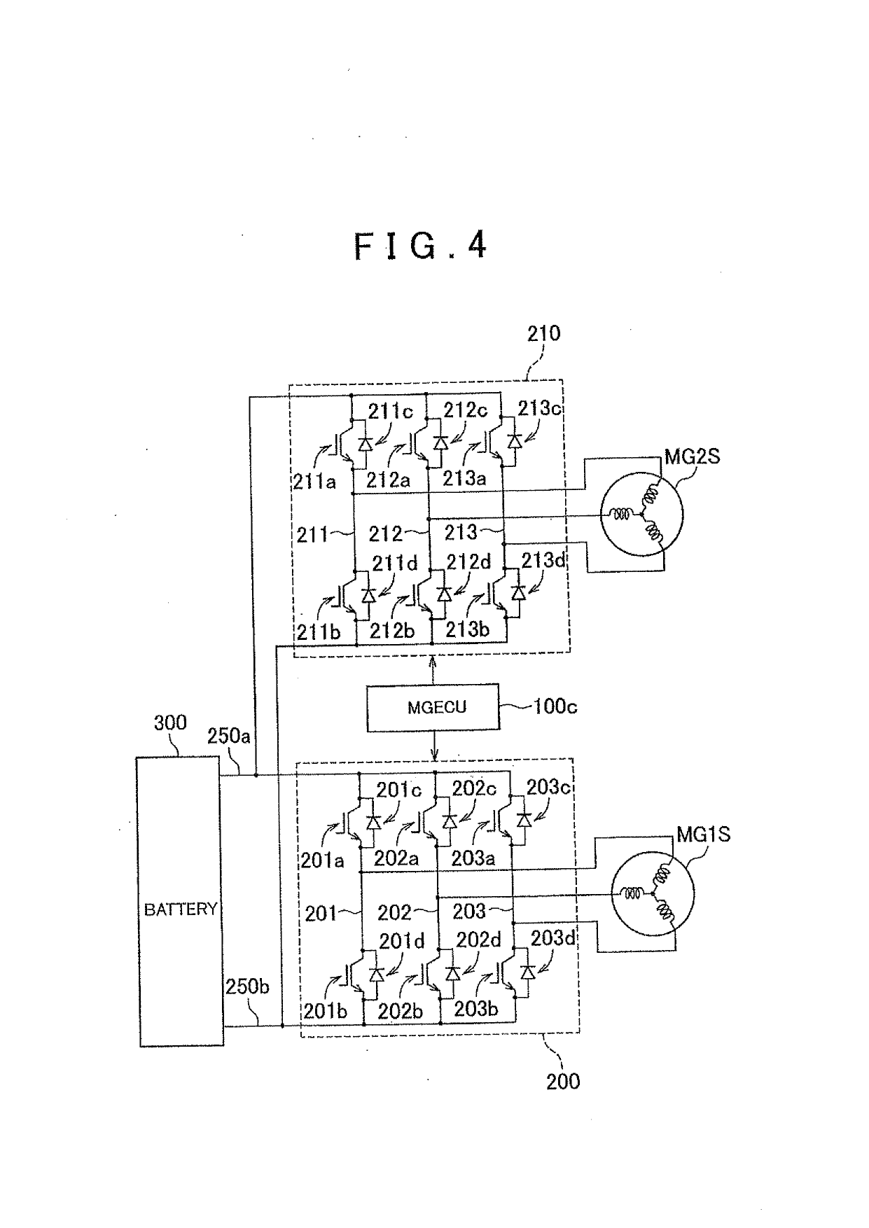

Specifically, the inverter 200 is a three phase bridge circuit as illustrated in FIG. 4. Additionally, the inverter 200 includes a U-phase arm 201, a V-phase arm 202, and a W-phase arm 203. The U-phase arm 201, the V-phase arm 202, and the W-phase arm 203 are connected between a positive electrode bus bar 250a and a negative electrode bus bar 250b in parallel.

The U-phase arm 201 includes Insulated Gate Bipolar Transistors (IGBTs) 201a and 201b and diodes 201c and 201d. The V-phase arm 202 includes IGBTs 202a and 202b and diodes 202e and 202d. The W-phase arm 203 includes IGBTs 203a and 203b and diodes 203c and 203d.

The IGBTs 201a, 201b, 202a, 202b, 203a, and 203b receive drive signals (PWM signals) output from a MGECU 100c at the respective gates, and control on/off-states corresponding to the drive signals.

In the IGBTs 201a, 202a, and 203a, respective collectors are connected to the positive electrode bus bar 250a, and respective emitters are connected to middle points of the respective phase arms. In the IGBTs 201b, 202b, and 203b, respective collectors are connected to middle points of the respective phase arms, and respective emitters are connected to the negative electrode bus bar 250b.

In the diodes 201e, 202c, and 203c, respective cathodes are connected to the positive electrode bus bar 250a, and respective anodes are connected to middle points of the respective phase anus. In the diodes 201d, 202d, and 203d, respective cathodes are connected to middle points of the respective phase arms, and respective anodes are connected to the negative electrode bus bar 250b.

The middle points of the respective phase arms are connected to one ends of the respective phase coils of the stator MG1S in the first motor-generator MG1. The respective phase coils each have the other end that is connected to the neutral point.

Similarly, the inverter 210 is a three phase bridge circuit. The inverter 210 includes a U-phase arm 211, a V-phase arm 212, and a W-phase arm 213. The U-phase arm 211, the V-phase arm 212, and the W-phase arm 213 are connected between the positive electrode bus bar 250a and the negative electrode bus bar 250b in parallel.

The U-phase arm 211 includes IGBTs 211a and 211b and diodes 211c and 211d. The V-phase arm 212 includes IGBTs 212a and 212b and diodes 212c and 212d. The W-phase arm 213 includes IGBTs 213a and 213b and diodes 213c and 213d.

The U-phase aim 211, the V-phase arm 212 and the W-phase arm 213 include the middle points of the respective phase arms that are connected to one ends of respective phase coils of the stator MG2S in the second motor-generator MG2. The U-phase arm 211, the V-phase arm 212, and the W-phase arm 213 are otherwise similar to the respective U-phase arm 201, V-phase arm 202 and W-phase arm 203 described above.

As illustrated in FIG. 1, the power split mechanism 3 includes a planetary gear mechanism. The planetary gear mechanism includes a sun gear 53, a pinion gear P3, a ring gear R3, and a planetary carrier CA3. The sun gear 83 is an external gear that rotates about the center of a plurality of gear components. The pinion gear P3 is an external gear that rotates and revolves around the sun gear 53 while being in contact with the outer side of the sun gear S3. The ring gear R3 is an internal gear that is formed in a hollow cylindrical shape to engage the pinion gear P3. The planetary carrier CA3 supports the pinion gear P3, and rotates with the revolution of the pinion gear P3. The planetary carrier CA3 is integrally coupled to the input shaft 21 at the side of the engine 1 so as to allow its rotation. The sun gear 83 is integrally coupled to the rotor MGIR of the first motor-generator MG1 so as to allow its rotation.

The power split mechanism 3 transmits at least one driving force of the engine 1 and the second motor-generator MG2 to the right and left driving wheels 6L and 6R through the counter drive gear 51, the counter driven gear 52, the final gear 53, the differential unit 54, and the drive shafts 61 and 61.

The power split mechanism 3 splits a power output from the engine 1 into a power transmitted to the sun gear 83 and a power transmitted to the ring gear R3.

Subsequently, the power transmitted to the sun gear 83 is transmitted to the first motor-generator MG1. This allows the first motor-generator MG1 to generate electric power. The first motor-generator MG1 also functions as a starter motor when starting the engine 1.

The reduction mechanism 4 includes a planetary gear mechanism. The planetary gear mechanism includes a sun gear 84, a carrier (transaxle case) CA4, a pinion gear P4, and a ring gear R4. The sun gear S4 is an external gear that rotates about the center of a plurality of gear components. The pinion gear P4 is an external gear that is rotatably supported by the carrier (transaxle case) CA4 and rotates in contact with the outer side of the sun gear 84. The ring gear R4 is an internal gear that is formed in a hollow cylindrical shape to engage the pinion gear P4. The ring gear R4 of the reduction mechanism 4, the ring gear R3 of the above-described power split mechanism 3, and the counter drive gear 51 are integrated with one another. The sun gear S4 is integrally coupled to the rotor MG2R of the second motor-generator MG2 and allows its rotation.

The reduction mechanism 4 decelerates a driving force of the second motor-generator MG2 at an appropriate reduction gear ratio. This decelerated driving force is transmitted to the right and left driving wheels 6L, and 6R through the counter drive gear 51, the counter driven gear 52, the final gear 53, the differential unit 54, and the drive shaft 61.

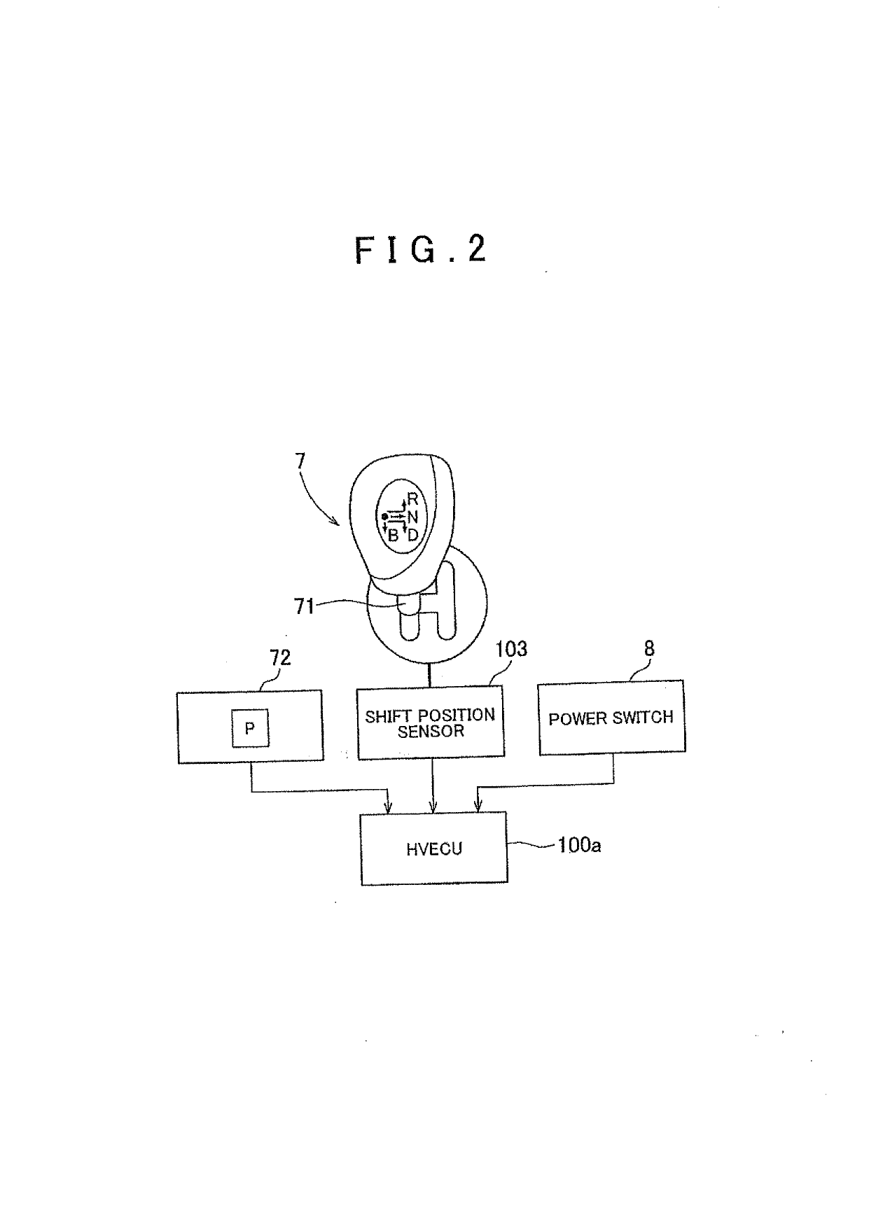

The hybrid vehicle Hy includes a shift operation device 7 (see FIG. 2) disposed in vicinity of a driver's seat. The shift operation device 7 is disposed to receive a switching instruction for the shift position of the hybrid vehicle HV from the driver. As illustrated in FIG. 2, this shift operation device 7 includes a shift lever 71 that allows its shifting. This exemplary shift operation device 7 includes a drive position (“D” position) for forward running, a brake position (“B” position) for forward running with a large braking force (of an engine brake) when the accelerator is turned off, a reverse position (“R” position) for reverse running, and a neutral position (“N” position) in neutral. The shift operation device 7 allows a driver to shift the shift lever 71 to a desired position. Each position of “D” position, “B” position, “R” position, and “N” position is detected by a shift position sensor 103. An output signal of the shift position sensor 103 is input to the HVECU 100a. A parking position switch 72 is disposed in vicinity of the shift lever 71 to set a parking position (“P” position) for parking. This P position switch 72 outputs an operation signal to the HVECU 100a in the event that an occupant including the driver operates the P position switch 72.

The hybrid vehicle HV includes a power switch 8 for starting and stopping the hybrid system (the vehicle system). This power switch 8 is, for example, a rebounding push switch. The power switch 8 is an example of “an operating unit” of the present invention.

Here, the hybrid system is a system that controls running of the hybrid vehicle HV by performing various controls including an operation control of the engine 1, drive controls of the motor-generators MG1 and MG2, a cooperative control of the engine 1 and the motor-generators MG1 and MG2, and similar control.

In the event that the power switch 8 is operated by an occupant including the driver, the power switch 8 outputs a signal corresponding to the operation to the HVECU 100a. The HVECU 100a initiates starting and stopping of the hybrid system based on, for example, the signal output from the power switch 8. That is, the power switch 8 is disposed to receive an operation from the occupant including the driver who starts and stops the hybrid system.

For example, when the hybrid system is starting and in the “P” position while the vehicle stops, the HVECU 100a stops the hybrid system in the case where the power switch 8 is operated (for example, short pressing).

For example, when the hybrid vehicle HV stops and the brake pedal is depressed, the HVECU 100a starts the hybrid system in the case where the power switch 8 is operated (for example, short pressing). A description will be given of an operation when the power switch 8 is operated during running of the hybrid vehicle HV in detail below.

The HVECU 100a is disposed to integrally control the hybrid vehicle HV. As illustrated in FIG. 3, the HVECU 100a is communicably connected to an engine ECU 100b, the MGECU 100c, and a battery ECU 100d. The HVECU 100a is an example of “a control unit” of the present invention.

The HVECU 100a is an electronic control device that runs the hybrid system described above, and includes a Central Processing Unit (CPU), a Read Only Memory (ROM), a Random Access Memory (RAM), a backup RAM, and similar member.

The ROM stores various control programs, a map that is referred when the various control programs are executed, and similar data. The CPU executes arithmetic processing based on the various control programs or the map, which are stored in the ROM. The RAM is a memory that temporarily stores a result of an arithmetic operation in the CPU, data input from each sensor, and similar data. The backup RAM is a non-volatile memory that stores data, for example, to be saved, for example, at ignition Off.

The HVECU 100a is connected to an accelerator position sensor 101, the throttle position sensor 102, the shift position sensor 103, the P position switch 72, the power switch 8, and similar sensor. Signals from the respective sensors are input to the HVECU 100a. The accelerator position sensor 101 detects the accelerator position that is an accelerator pedal depressing amount.

The HVECU 100a has a function that controls the shift position of the hybrid vehicle HV. Specifically, the HVECU 100a is configured to switch the shift position corresponding to output signals from the shift position sensor 103 and the P position switch 72, and reject a switching instruction of the shift position depending on a condition of the hybrid vehicle NV. For example, the HVECU 100a switches the shift position to the “N” position in the event that a switching instruction to the “P” position is made during running of the hybrid vehicle NV.

The HVECU 100a allows a parking lock mechanism (not shown) to operate in the case where the shift position is set to the “P” position. This restricts movement of the hybrid vehicle NV. The HVECU 100a performs a cooperative control of the engine 1 and the motor-generators MG1 and MG2 in the case where the shift position is set to the “D” position or the “B” position. This makes the hybrid vehicle HV to be able to move forward. The HVECU 100a performs a cooperative control of the engine 1 and the motor-generators MG1 and MG2 in the case where the shift position is set to the “R” position. This makes the hybrid vehicle NV to be able to move backward.

The HVECU 100a stops the inverters 200 and 210 in the case where the shift position is set to the “N” position. In other words, the HVECU 100a stops the inverters 200 and 210 when the shift position is set to the “N” position is made during stopping of the hybrid vehicle NV. This does not allow the power of the engine 1 to transmit to the driving wheels 6L and 6R. Stopping the inverter 200 means cutting off of the IGBTs 201a, 201b, 202a, 202b, 203a, and 203h of the inverter 200 at the gates (make the IGBTs in off state). Stopping the inverter 210 means cutting off of the IGBTs 211a, 211b, 212a, 212b, 213a, and 213b of the inverter 210 at the gates (make the IGBTs in off state). That is, the HVECU 100a controls the output of the drive signals to stop the MGECU 100c in the case where the shift position is set to the “N” position. Here, in the hybrid vehicle HV, the first motor-generator MG1 functions as a starter motor. Thus, the stopped inverter 200 does not allow cranking of the engine 1. This is not able to start the engine 1.

The engine ECU 100b is connected to the throttle motor 14, which drives the throttle valve 13 of the engine 1 to open and close, a fuel injection unit (the injector) 15, an ignition unit 16, and similar unit.

Then, the engine ECU 100b performs various controls of the engine 1 including a throttle position control (air intake quantity control) of the engine 1, a fuel injection quantity control, an ignition timing control, and similar control based on output signals from the above-described various sensors.

The MGECU 100c generates drive signals to the inverters 200 and 210 based on an output request and similar request from the HVECU 100a, and outputs the drive signals to the inverters 200 and 210. Accordingly, outputting the drive signals from the MGECU 1000 to the inverters 200 and 210 operates (drives) the inverters 200 and 210, and stopping the output of drive signals from the MGECU 100c stops the inverters 200 and 210.

The battery ECU 100d detects a voltage, a charge/discharge current, and a temperature of the battery 300, and transmits the detection result to the HVECU 100a. Subsequently, the HVECU 100a calculates State of Charge (SOC) of the battery 300 based on an integrated value of the charge/discharge current, and calculates an input limitation Win and an output limitation Wout of the battery 300 based on a charged state and a temperature.

The hybrid vehicle HV according to this embodiment runs using the second motor-generator MG2 only (hereinafter also referred to as “EV running”) in the case where an operational efficiency of the engine 1 is poor, for example, at the start of running and at low-speed running. The EV running is also performed in the case where the driver selects an EV running mode using a running mode selection switch that is disposed in the vehicle interior.

On the other hand, during normal running, for example, the above-described power split mechanism 3 splits a power of the engine 1 into two paths (torque split). One power directly drives the driving wheels 6L and 6R (drive by direct torque). The other power drives the first motor-generator MG1 to generate electric power. At this time, the generated electric power drives the second motor-generator MG2 to assist driving of the driving wheels 6L and 6R (drive through an electric path). Thus, the above-described power split mechanism 3 functions as a differential mechanism. This differential operation mechanically transmits a main part of the power from the engine 1 to the driving wheels 6L and 6R. The rest of the power from the engine 1 is electrically transmitted using the electric path from the first motor-generator MG1 to the second motor-generator MG2. This provides a function as a transmission that electrically changes a gear ratio. This allows freely operating engine rotation speed and engine torque without depending on the rotation speed and the torque of the driving wheels 6L and 6R (the ring gears R3 and R4). This allows obtaining an operating state of the engine where a fuel consumption rate is optimized while obtaining a driving force required for the driving wheels 6L and 6R.

At high-speed running, an electric power from the battery (a battery for running) 300 is additionally supplied to the second motor-generator MG2. Thus, the output of the second motor-generator MG2 is increased to add a driving force to the driving wheels 6L and 6R (assist of the driving force, power running).

Additionally, at deceleration, the second motor-generator MG2 functions as an electric generator, and generates regenerative power to store the recovered electric power in the battery 300. In the case where a charge amount of the battery 300 is reduced and charge is especially required, the output of the engine 1 increases to increase the electricity amount generated by the first motor-generator MG1. This consequently increases the charge amount for the battery 300. At low-speed running, a control to increase the output of the engine 1 may be performed as necessary. For example, this control is performed in the case where the battery 300 is required to be charged as described above, in the case where accessories such as an air conditioner are driven, in the case where a temperature of cooling water of the engine 1 is increased to a predetermined temperature, or similar case.

Additionally, the above-described hybrid vehicle HV stops the engine 1 to improve fuel efficiency in the case where an EV running condition that is determined based on an operating state of the hybrid vehicle HV, a state of the battery 300, and similar parameter is satisfied. In the case where the EV running condition is not satisfied, the engine 1 is started again. Thus, in the hybrid vehicle HV, the engine 1 intermittently operates even in an ignition On state.

Next, a description will be given of a starting process of the hybrid system in the hybrid vehicle HV for respective cases of stopping and running. The following process is performed by the HVECU 100a.

At stopping of the vehicle, in the event that the power switch 8 is operated (for example, by short pressing) while the brake pedal is depressed, the starting process of the hybrid system is initiated. First, a system check, which is preliminarily set, is performed. Subsequently, a system main relay (not shown) is connected after completion of the system check. The shift position is set to the “P” position.

This system main relay is a relay to connect or cut off between the battery 300 and the inverters 200 and 210. Accordingly, connecting of the system main relay allows the motor-generators MG1 and MG2 to drive by electric power supplied from the battery 300. This also allows charging the battery 300 with electric power, which is generated by the motor-generators MG1 and MO2.

For example, in the case where the engine 1 is cold or in the case where the SOC of the battery 300 is low, that is, in the case where the EV running condition is not satisfied, the engine 1 is started. The engine 1 is started by the first motor-generator MG1 that is driven by the electric power of the battery 300. Subsequently, the state of the engine 1 turns into a Ready-On state (a state that allows running), and an indicator lamp that indicates this state on a combination meter (not shown) is lighted.

On the other hand, for example, in the case where the engine 1 does not need to be warmed up, or in the case where the battery 300 does not need to be charged, that is, in the case where the EV running condition is satisfied, the state turns into the Ready-On state without starting the engine 1, and the indicator lamp that indicates this state on the combination meter is lighted.

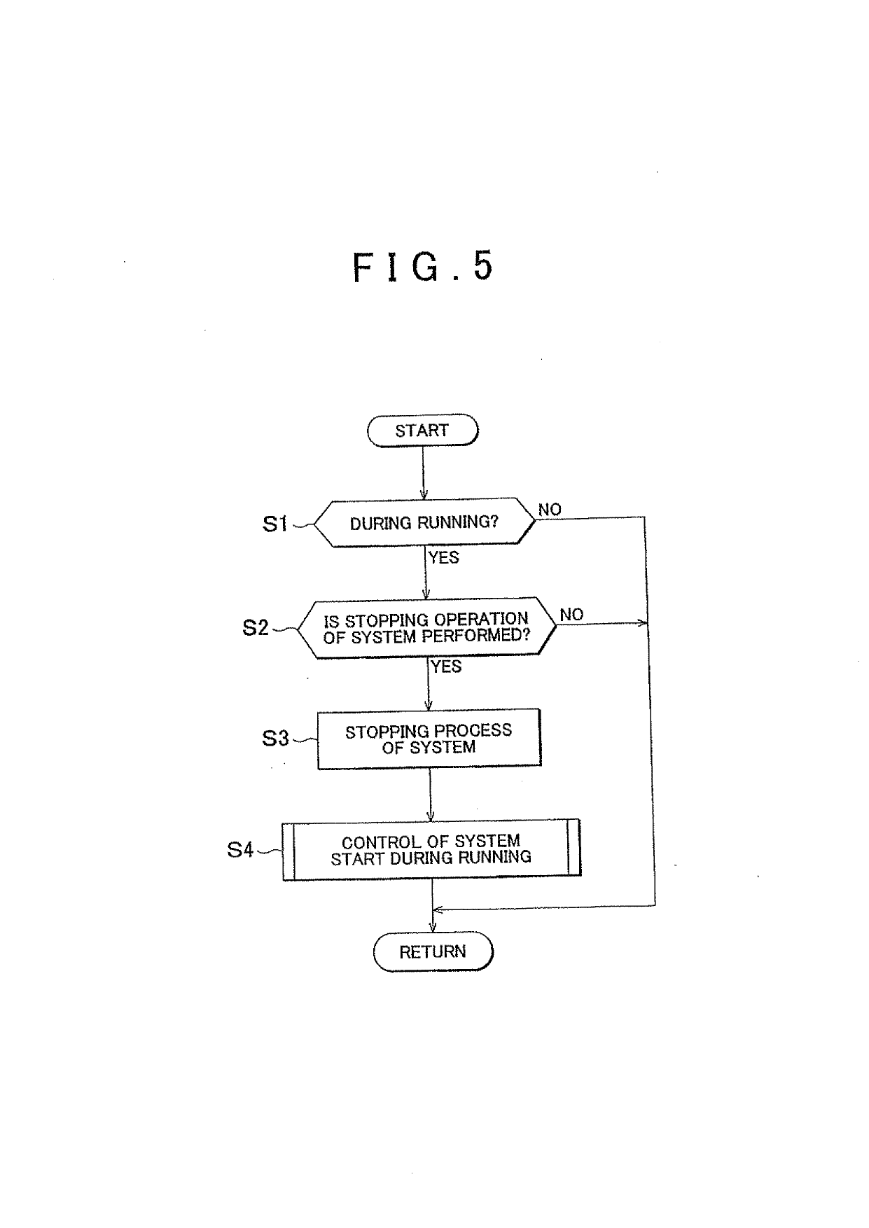

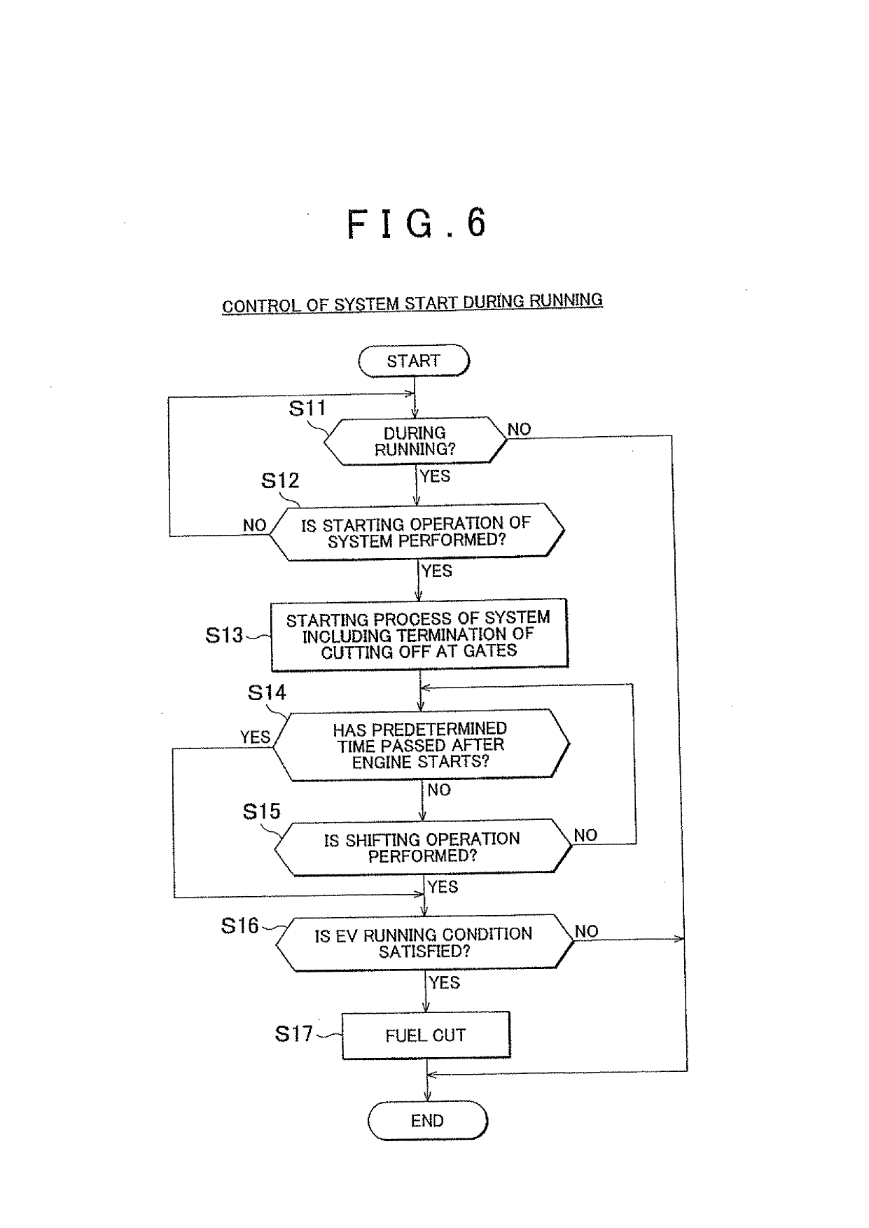

FIG. 5 and FIG. 6 are flowcharts to explain the starting process of the hybrid system when the hybrid vehicle runs. A description will be given of the starting process of the hybrid system while the hybrid vehicle ITV is running by referring to FIG. 5 and FIG. 6. In order to start running of the hybrid vehicle HV, the hybrid system is required to be started. At normal running of the vehicle, the hybrid system is started. Hereinafter, a description will be given of a sequence of processes from stopping to restarting of the hybrid system during running of the vehicle.

First, at step S1 in FIG. 5, the HVECU 100a determines whether or not the vehicle is running. The HVECU 100a determines whether or not the vehicle is running, for example, based on a signal output from a vehicle speed sensor (not shown). This running may be any of EV running, running with the power of the engine 1 only, and running with the power of the engine 1 assisted by the second motor-generator MG2.

At this time, the shift position is, for example, the “D” position. The shift position may be the “B” position or the “N” position. In the case where the vehicle is determined to be running, the process proceeds to step S2. On the other hand, in the case where the vehicle is determined not to be running, the process proceeds to RETURN.

Subsequently, at step S2, the HVECU 100a determines whether or not a stopping operation (for example, long pressing of the power switch 8) of the hybrid system is performed. Specifically, the HVECU 100a determines whether or not the stopping operation is performed based on the signal output from the power switch 8. In the case where the stopping operation of the hybrid system is determined to be performed, the process proceeds to step S3. On the other hand, in the case where the stopping operation of the hybrid system is determined not to be performed, the process proceeds to RETURN.

Subsequently, at step S3, the HVECU 100a starts the stopping process of the hybrid system. This stopping process of the hybrid system includes stopping of the engine 1 by a fuel cut, for example, in the case where the engine 1 is driven, stopping of the driving of the motor-generators MG1 and MG2 by cutting off of the inverters 200 and 210 at the gates, cutting off the system main relay, and similar process. The indicator lamp that indicates the Ready-On state may be turned off when the stopping process of the hybrid system is started.

Subsequently, at step S4, the HVECU 100a performs a control of system start during running. After this control of system start during running is terminated (ended), the process proceeds to RETURN.

In this control of system start during running, the HVECU 100a determines whether or not the vehicle is running at step S11 in FIG. 6. In the case where the vehicle is determined to be running, the process proceeds to step S2. On the other hand, in the case where vehicle is determined not to be running, freewheeling is stopped, and the process proceeds to END without performing the system start during running of the vehicle.

Subsequently, at step S12, the HVECU 100a determines whether or not a starting operation (for example, short pressing of the power switch 8) of the hybrid system is performed. Specifically, the HVECU 100a determines whether or not the starting operation is performed based on the signal output from the power switch 8. In the case where the starting operation of the hybrid system is determined to be performed, the process proceeds to step S13. On the other hand, in the case where the starting operation of the hybrid system is determined not to be performed, the process returns to step S11.

Subsequently, at step S13, the HVECU 100a performs the starting process of the hybrid system including a connection of invertors at the gates. This starting process of the hybrid system includes, for example, a system check, connecting of the system main relay, connection of the inverters 200 and 210 at the gates, starting of the engine 1, and similar process. At this starting process of the hybrid system, the shift position is set to, for example, the “N” position. That is, in the case where starting of the hybrid system is performed when the hybrid vehicle HV runs, cutting off of the inverters 200 and 210 each is connected at their gates (to cause the inverters 200 and 210 to operate) even if the shift position is in the “N” position. Therefore, in this embodiment, in the case where the shift position is in the “N” position in a normal operation, the inverters 200 and 210 are cut off at the gates. On the other hand, even if the shift position is in the “N” position when the hybrid system restarts during running, the inverters 200 and 210 each is exceptionally connected at the gates.

Accordingly, even if the shift position is in the “N” position, the first motor-generator MG1 allows cranking of the engine 1, thus enabling the start of the engine 1. This starting of the engine 1 is performed regardless if the EV running condition is satisfied or not. Subsequently, the starting process is completed, and as its result, the state of the vehicle becomes into the Ready-On state and the indicator lamp that indicates this state on the combination meter is lighted.

This starting of the engine 1 is performed in order to notify the occupant including the driver about the reception of the starting operation. In view of this, outputting the power of the engine 1 to the drive shaft 61 may degrade drivability. Therefore, when starting the engine 1, the motor-generators MG1 and MG2 are cooperatively controlled to reduce the power of the engine 1 that is output to the drive shaft 61.

Subsequently, at step S14, the HVECU 100a determines whether or not a predetermined time has passed after the engine 1 starts. The predetermined time is a time that is preliminarily set, for example, 10 seconds. Subsequently, in the case where the predetermined time is determined not to have passed, the process proceeds to step S15. On the other hand, in the case where the predetermined time is determined to have passed, the process proceeds to step S16.

Subsequently, at step S15, the HVECU 100a determines whether or not the shift lever 71 (see FIG. 2) is operated. This operation of the shift lever 71 is, for example, an operation where the shift lever 71 is set to the “D” position from the “N” position. The HVECU 100a determines whether or not the shift lever 71 is operated based on the signal output from the shift position sensor 103. In the case where the shift lever 71 is determined not to be operated, the process proceeds to step S14. On the other hand, in the case where the shift fever 71 is determined to be operated, the process proceeds to step S16.

Subsequently, at step S16, the HVECU 100a determines whether or not the EV running condition is satisfied based on the operating state of the hybrid vehicle HV, the state of the battery 300, and similar state. In the case where the EV running condition is determined to be satisfied, the process proceeds to step S17. On the other hand, in the case where the EV running condition is determined not to be satisfied, the engine 1 continues to be driven. The process proceeds to END.

Subsequently, at step S17, the HVECU 100a performs a fuel cut and stops the driving of the engine 1. The process proceeds to END in a state of the EV running.

In this embodiment, as described above, the hybrid system is stopped by performing the stopping operation of the hybrid system during running of the vehicle. Subsequently, the starting operation of the hybrid system is performed before the hybrid vehicle HV is stopped. In this case, even if the shift position is set to the “N” position, operating the inverter 200 allows driving the first motor-generator MG1, thus allowing the cranking of the engine 1. This enables the engine 1 to start. Since the starting of the engine 1 causes sound and vibration, the driver can easily recognize the reception of the starting operation.

In this embodiment, by performing the stopping operation of the hybrid system during running of the vehicle, the hybrid system is stopped. Subsequently, the starting operation of the hybrid system is performed before the hybrid vehicle HV is stopped. In this case, even if the shift position is set to the “N” position, operating the inverter 210 allows controlling the second motor-generator MG2 so as to cancel cranking torque. This prevents degradation of drivability.

In this case, the HVECU 100a may stop the inverters 200 and 210 in the case where the operation to stop the hybrid system is performed during running of the vehicle.

This configuration causes the inverters 200 and 210, which are stopped, to operate in the case where the operating unit receives the operation to start the hybrid system before the running is stopped.

In this embodiment, in the case where the predetermined time has passed after the engine 1 starts (Yes in step S14) and the EV running condition is satisfied (Yes in step S16), the driving of the engine 1 is stopped. This prevents the driver from being misled into thinking that engine stall has occurred, and also reduces fuel consumption of the engine 1. That is, this prevents degradation of fuel efficiency.

In this embodiment, in the case where the shift lever 71 is operated (Yes in step S15) and the EV running condition is satisfied (Yes in step S16), the driving of the engine 1 is stopped. This reduces unnecessary fuel consumption of the engine 1 after the driver recognizes the reception of the starting operation.

The above-described disclosed embodiments are considered in all respects as illustrative and not restrictive. The scope of the invention is indicated by the appended claims rather than by the foregoing description. All variations and modifications falling within the equivalency range of the appended claims are intended to be embraced therein.

For example, while in this embodiment, the present invention is applied to the FF hybrid vehicle HV as the example, this should not be construed in a limiting sense. The present invention may be applied to an FR hybrid vehicle or a 4WD hybrid vehicle.

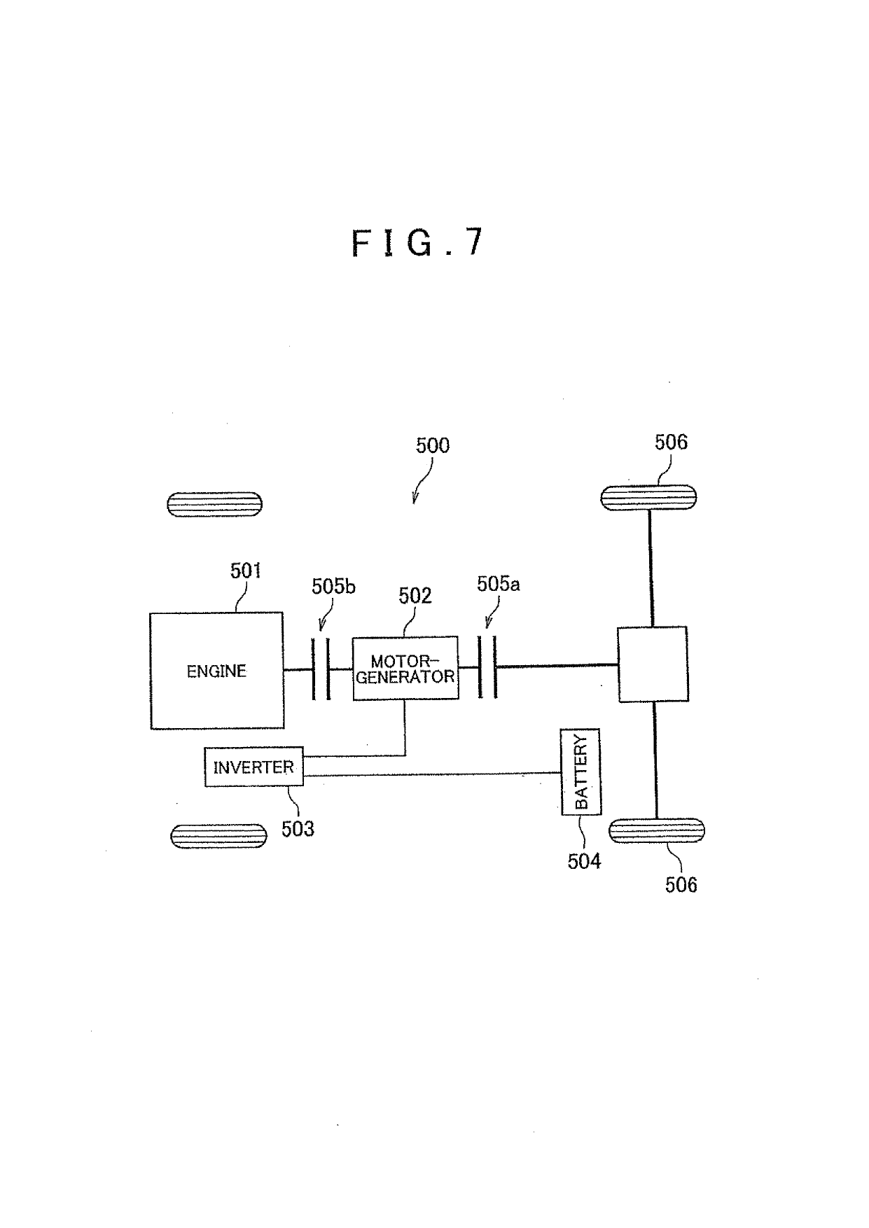

For example, like a modification illustrated in FIG. 7, the present invention may be applied to an FR hybrid vehicle 500. This hybrid vehicle 500 includes an engine 501, a motor-generator 502, an inverter 503, and a battery 504. The motor-generator 502 functions as a power engine and an electric generator. The inverter 503 drives the motor-generator 502. The battery 504 supplies an electric power to drive the motor-generator 502, and stores the electric power generated by the motor-generator 502. In the hybrid vehicle 500, a clutch 505a is engaged, and a clutch 505b is disengaged. This allows the motor-generator 502 alone to drive a rear wheel 506. Coupling both of the clutches 505a and 505b allows the engine 501 to drive the rear wheel 506, and also allows the motor-generator 502 to charge the battery 504 or generate assist torque.

At step S13 in this embodiment, the inverters 200 and 210 may be ant off at the gates after the engine 1 starts. Alternatively, the inverters 200 and 210 at the gates each may be kept connected.

While in this embodiment, the two motor-generators MG1 and MG2 are disposed in the hybrid vehicle HV as an example, this should not be construed in a limiting sense. One or equal to or more than three motor-generators may be disposed in the hybrid vehicle. For example, in the hybrid vehicle HV of this embodiment, a third motor-generator that chives a rear wheel shaft may be disposed in addition to the first motor-generator MG1 and the second motor-generator MG2.

While in this embodiment, the power switch g that is a rebounding push switch is described as an exemplary operating unit of the present invention, this should not be construed in a limiting sense. Any other configuration is possible insofar as the operating unit of the present invention can receive an operation. For example, the operating unit of the present invention may employ a lever switch, a slide switch, a key switch where a key is inserted into a cylinder and rotated, or similar switch.

In this embodiment, after the stopping process of the hybrid system, which starts at step S3, is wholly completed, that is, in a state where the hybrid system is completely stopped, the starting operation of the hybrid system at step S12 may be performed. Before the stopping process of the hybrid system, which starts at step S3, is wholly completed, that is, in a state where only a part of the hybrid system is terminated and the rest of the part is started, the starting operation of the hybrid system at step S12 may be performed.

At step S13 in this the embodiment, in the case where the starting process of the hybrid system that includes starting of the engine 1 is performed, a part of the starting process is not necessary to be performed. For example, in the case where the engine 1 is disabled and the hybrid vehicle HV has a trouble caused by starting of the engine 1 or similar case, the process may prohibit staring of the engine 1.

While in this embodiment, the inverters 200 and 210 each is connected at the gates when the hybrid system is restarted as an example, this should not be construed in a limiting sense. In the case where a predetermined condition such as depressing of the accelerator pedal is satisfied when the hybrid system is restarted, the inverters 200 and 210 each may be connected at the gates.

While in this embodiment, the inverters 200 and 210 each is connected at the gates even if the shift position is in the “N” position when the hybrid system is restarted as an example, this should not be construed in a limiting sense. In the case where the shift position is in the “N” position when the hybrid system is restarted, the shift position may be assumed to be the “D” position so as to connect each the inverters 200 and 210 at the gates.

While in this embodiment, long pressing of the power switch 8 is described as an exemplary stopping operation of the hybrid system during running, this should not be construed in a limiting sense. The stopping operation of the hybrid system may be several times of short pressing of the power switch 8. Also, the same stopping operation of the hybrid system may be used during stopping and during running of the hybrid vehicle HV.

In this embodiment, a buck-boost converter may be disposed between the inverters 200 and 210 and the battery 300.

While in this embodiment, the IGBTs are described as exemplary switching elements of the inverters 200 and 210, this should not be construed in a limiting sense. A power MOSFET may be used for switching elements of the inverters 200 and 210.

While at step S14 in this embodiment, this example determines whether or not the predetermined time has passed after the engine 1 starts, this should not be construed in a limiting sense. It is also possible to determine whether or not the predetermined time has passed after the starting operation of the hybrid system is performed.

In this embodiment, the predetermined time may be a fixed value. The predetermined time may vary. For example, the predetermined time may be varied by calculating various parameters.

In this embodiment, only in the case where a predetermined operation (for example, setting of the shift position to the “D” position from the “N” position) of the shift lever 71 is performed, the engine 1 may be stopped. In the ease where any operation of the shift lever 71 is performed, the engine 1 may also be stopped.

While in this embodiment, in the case where the EV running condition is satisfied (Yes in step S16), the engine 1 is stopped (step S17) as an example, this should not be construed in a limiting sense. In the case where a predetermined time has passed after the engine 1 starts or in the case where a shifting operation is performed, the engine 1 may be stopped. That is, step S16 in FIG. 5 may be omitted.

While in this embodiment, the hybrid system is started in the case where the power switch 8 is operated during running without depressing of the brake pedal, this should not be construed in a limiting sense. Even when running, the hybrid system may be started by operation of the power switch 8 only when the brake pedal is depressed. In the case where the power switch 8 is operated in a state where the brake pedal is not depressed while the hybrid vehicle HV stops, for example, only accessories may be allowed to be driven (what is called accessory On).

While in this embodiment, the example allows the engine to start when the hybrid system-restarts during running, this should not be construed in a limiting sense. In the case where the stopping operation of the hybrid system is performed during running of the vehicle, even if the vehicle stops afterward, the engine may be started when restarting the hybrid system.

While the disclosure has been explained in conjunction with specific exemplary embodiments thereof, it is evident that many alternatives, modifications, and variations will be apparent to those skilled in the art. Accordingly, exemplary embodiments of the disclosure as set forth herein are intended to be illustrative, not limiting. There are changes that may be made without departing from the scope of the disclosure.

What is claimed is:

1. A vehicle comprising:
an engine;
a first electric machine configured to allow cranking the engine;
a first inverter configured to drive the first electric machine;
a control unit configured to control the first inverter; and
an operating unit configured to receive operations to start and stop a vehicle system, the vehicle system controlling running of the vehicle, wherein
the control unit is configure so that, during running of the vehicle, when the operating unit receives the operation to stop the vehicle system, and then the operating unit receives the operation to start the vehicle system before the vehicle stops, the control unit operates the first inverter.

2. The vehicle according to claim 1, wherein
the control unit stops the first inverter when a shift position is in a neutral position during stopping of the vehicle.

3. The vehicle according to claim 1, wherein
the control unit is configured so that, during running of the vehicle, when the operating unit receives the operation to stop the vehicle system, and then the operating unit receives the operation to start the vehicle system before the vehicle stops, the control unit controls the first inverter such that the first electric machine cranks the engine.

4. The vehicle according to claim 1, further comprising
a second electric machine configured to run the vehicle, and a second inverter that drives the second electric machine, wherein
the control unit is configured so that, during running of the vehicle, when the operating unit receives the operation to stop the vehicle system, and then the operating unit receives the operation to start the vehicle system before the vehicle stops, the control unit causes the second inverter to operate.

5. The vehicle according to claim 4, wherein
the control unit is configured to stop the first inverter and the second inverter when the operating unit receives the operation to stop the vehicle system during running of the vehicle.

6. A vehicle comprising:
an engine;
a first electric machine configured to allow cranking the engine;
a first inverter configured to drive drives the first electric machine;
a control unit configured to control the first inverter; and
an operating unit configured to receive operations to start and stop a vehicle system, the vehicle system controlling running of the vehicle, wherein
the control unit is configured so that, during running of the vehicle, when the occupant performs the operation to stop the vehicle system, and then the occupant performs the operation to start the vehicle system through the operating unit before the vehicle stops, the control unit operates the first inverter.

7. A vehicle comprising:
an engine;
a first electric machine configured to allow cranking the engine;
a first inverter configured to drive the first electric machine;
a control unit configured to control the first inverter; and
an operating unit configured to receive operations to start and stop a vehicle system, the vehicle system controlling running of the vehicle, wherein
the control unit is configured so that, during running of the vehicle, when the control unit receives a signal to stop the vehicle system from the operating unit, and then the control unit receives a signal to start the vehicle system from the operating unit before the vehicle stops, the control operates the first inverter.
